(19) United States
(12) Patent Application Publication
(10) Pub. No.: US 2005/0072540 A1
(43) Pub. Date: Apr. 7, 2005

(54) System and method for creping electrical insulating paper

(75) Inventor: Richard P. Skowronski JR., Douglas, MA (US)

Correspondence Address: DOWNS RACHLIN MARTIN PLLC, 199 MAIN STREET, P O BOX 190, BURLINGTON, VT, 05402-0190, US

(73) Assignee: EHV-Weidmann Industries Inc., St. Johnsbury, VT (US)

(21) Appl. No.: 10/939,041

(22) Filed: Sep. 10, 2004

Related U.S. Application Data
(60) Provisional application No. 60/502,683, filed on Sep. 12, 2003.

(51) Int. Cl. B31F 1/12

(52) U.S. Cl. 162/111; 162/138; 162/280; 162/281; 162/361; 156/183; 264/282

(57) ABSTRACT

A creping system (20) that includes a roller (28) for adheringly receiving kraft paper (24) and a creping knife (36) for creping the kraft paper from the roller. The creping knife has a ceramic tip (100) that engages the roller and induces a creping pattern into the kraft paper as the paper is creped from the roller. The ceramic tip provides a number of benefits to the creping system, including the ability to crepe multiple rolls (44, 48, 52) of kraft paper continuously and providing a creped paper (76, 76′) having characteristics superior to creped paper made using a conventional creping knife.

### RELATED APPLICATION DATA

This application claims the benefit of priority of U.S. Provisional Patent Application Ser. No. 60/502,683, filed Sep. 12, 2003, and titled “System and Method for Creping Electrical Insulating Paper,” that is incorporated by reference herein in its entirety.

### FIELD OF THE INVENTION

The present invention generally relates to the field of paper converting. In particular, the present invention is directed to a system and method for creping electrical insulating paper.

### BACKGROUND OF THE INVENTION

Paper is used widely in the electrical equipment manufacturing industries as electrical insulation for various electrical conductors and other parts. For example, in the transformer industry, paper is used to insulate the magnet wires that make up the core windings of the transformers. Generally, this paper is wrapped around each magnet wire so as to electrically insulate each portion of the wound wire from other portions of the wire in the winding. Typically, such insulating paper is creped and calendered electrical kraft paper having certain electrical properties so as to provide the necessary insulating properties. In addition to particular electrical properties, the kraft paper used for electrical insulation typically has a relatively high tensile strength, at least along the length of the paper. Often, such kraft paper is made from a furnish having a relative large percent composition, e.g., 70% or more, of virgin softwood fibers, which give the paper much of its tensile strength. Electrical kraft paper often contains 100% unbleached sulfate fibers so as to meet the American National Standards Institute (ANSI) and American Society for the Testing of Materials (ASTM) specification D-1305-99, “Specification for Electrical Insulating Paper and Paperboard-Sulfate (Kraft) Layer Type,” which is an accepted specification for electrical kraft paper.

A common method of creping electrical insulating papers is performed in a continuous-web process wherein a web of roll-base electrical kraft paper is adhered to a creping roll and then creped from the creping roll with a creping blade that imparts a desired creping pattern into the paper. Following creping, the creped web is typically calendered and dried to form a finished insulating paper product. Conventionally, the creping roll has a very smooth peripheral surface for receiving the base kraft paper. During creping, the base kraft paper is supplied to the creping roll from a roll of such paper. As the paper travels toward the creping roll, it is treated with a creping solution for adhering the paper to the creping roll with the adherence necessary to create the desired creping pattern. As those skilled in the art know, the amount of adherence of the paper to the creping roll can be adjusted by changing variables such as the composition of the creping solution, the amount of solution and the amount the solution is dried prior to the web being scraped from the creping roll, among others.

For many years a large portion of the electrical insulating paper creping industry has utilized creping blades made of a metal, e.g., brass, that is softer than the material of the creping roll so as to minimize the damage that the blade causes to the roll. Changing a roll in order to regrind or replace the roll is much more expensive in terms of both time and money than regrinding or replacing a creping blade. Hence, conventional maintenance procedures require periodic regrinding or replacing of the creping blade. Since the creping blade is relatively soft, it wears relatively quickly from both the contact with the surface of the roll and the impact of the kraft paper web on the impact surface of the blade during creping. Consequently, the creping blade needs to be sharpened or replaced very frequently in order for the creped paper to remain within specifications. For example, it is common in the creping of base kraft paper having thicknesses of 2 mils or more to have to sharpen or replace a creping blade after creping only on the order of 13,000 lineal feet, or the amount typically contained in a single roll of base paper. Accordingly, it is common to sharpen or replace a metal creping blade with each new roll of base paper.

Sharpening a used blade is a time-intensive process that requires the creping system to be down for at least 15 minutes to a half hour. In addition, metal blades also require regrinding from time to time and new blades must be “run-in” prior to use. Regrinding and run-in require the creping roll to be run with the creping blade in full contact with the roll, but without the presence of the paper web. Regrinding a used blade after creping a roll of base paper can take about an hour. Grinding a new blade often takes 4 to 6 hours. Replacing a blade with a different blade in order to crepe a different product also requires allowing the creping roll to run against the blade for about an hour. As can be readily appreciated, since the creping roll cannot be used to crepe paper during regrinding, the productivity, e.g., the percentage of time during which a product meeting specifications is being made over a certain period of time, of conventional electrical insulating paper creping machines is severely constrained. What is needed is an electrical insulating paper creping machine having a higher productivity.

### SUMMARY OF INVENTION

In one aspect, the present invention is directed to a method of converting paper. The method comprises the steps of providing a first web of kraft paper and adhering the first web to a roller. The first web is creped from the roller with a creping blade having a ceramic tip.

In another aspect, the present invention is directed to a system for converting paper. The system comprises a first web of kraft paper and a roll having a peripheral surface for adheringly receiving the first web. A creping blade having a ceramic tip engages the peripheral surface. The creping blade removes the first web from the peripheral surface so as to impart a creping pattern into the first web.

In a further aspect, the present invention is directed to electrical insulation comprising an electrical kraft paper having a machine direction and defining a plane. A creping pattern is imparted into the electrical kraft paper along the machine direction and has a plurality of peaks and a plurality of valleys. Each of the plurality of valleys is defined by a pair of walls each having a slope of at least 45° relative to the plane.

### DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a simplified schematic diagram of a creping system of the present invention;

FIG. 2 is an enlarged view of a portion of the creping blade of the creping system of FIG. 1;

FIG. 3 is an enlarged view of a portion of the creping system of FIG. 1 showing details of the creping blade and blade holder;

FIG. 4 is a scanning electron micrograph of a prior art creped web made using a brass creping blade;

FIG. 5 is a scanning electron micrograph of a creped web of the present invention made using a ceramic-tipped creping blade; and

FIGS. 6A-6D each contain six-sigma I & MR charts comparing machine direction tensile strengths of creped paper samples made using conventional brass blades and ceramic-tipped blades of the present invention.

### DETAILED DESCRIPTION OF THE DRAWINGS

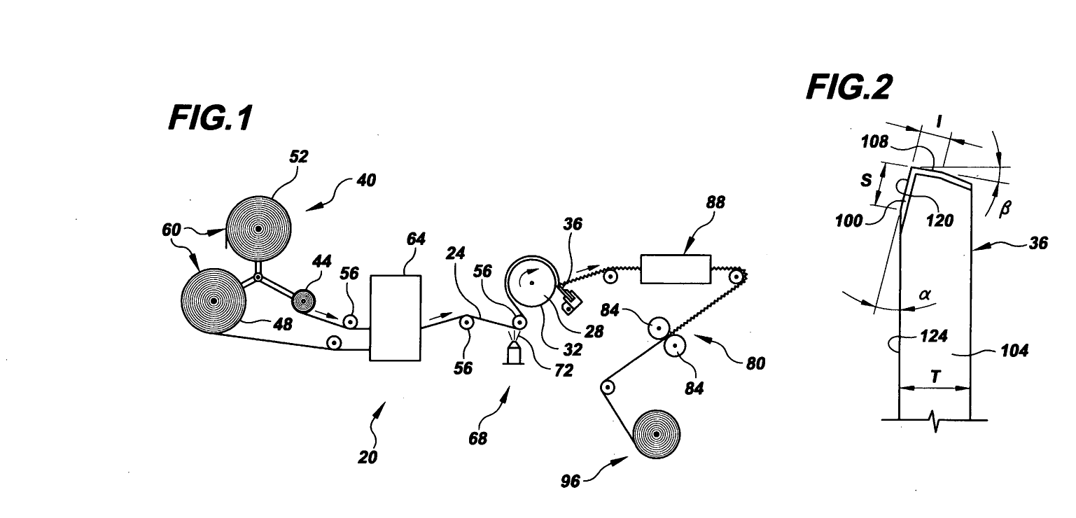

Referring now to the drawings, FIG. 1 shows in accordance with the present invention a creping system 20 for creping kraft paper 24, e.g., electrical kraft paper. Creping system 20 may include a creping roll 28 having a cylindrical peripheral surface 32 for adheringly receiving kraft paper 24. Creping roll 28 may be made out of any suitable material, such as metal. As those skilled in the art will readily appreciate, the present invention may be retrofitted to existing kraft paper creping equipment, and, therefore, creping roll 28 may be an existing creping roll. Of course, if creping system 20 is new, creping roll 28 may be newly fabricated. A ceramic-tipped creping blade 36 is in intimate contact with peripheral surface 32 for creping kraft paper 24 from creping roll 28.

As discussed in detail below, certain features of creping blade 36 provide a number of substantial benefits heretofore not realized in the kraft paper creping industry. As used herein, the term “ceramic-tipped” and similar terms mean that at least the portion of creping blade 36 that contacts creping roll 28 comprises a ceramic material. As such, this term encompasses the situation wherein only the portion of creping blade 36 that contacts creping roll 28 comprises a ceramic material and the situation wherein the entire blade is made of a ceramic material. Of course, all intermediate situations between these two extremes are encompassed by the term “ceramic-tipped” and like terms. Details of ceramic-tipped creping blade 36 are discussed below.

Creping system 20 may further include a roll feeder 40 for feeding rolls 44, 48, 52 of kraft paper 24 via a plurality of idler and other rollers 56 to creping roll 28. Roll feeder 40 may include one or more roll stations 60 for receiving rolls 44, 48, 52. In the embodiment shown, roll feeder 40 includes three roll stations 60 that may be used to cooperate with an optional auto-splicer 64, e.g., a “zero speed” auto-splicer, that automatically splices two rolls together while creping, calendering and winding remain at full production speed. Zero-speed and other auto-splicers 64 are well known in the paper converting and paper finishing industries, such that a detailed description is not necessary herein for those skilled in the art to understand the present invention. As those skilled in the art will readily appreciate, three roll stations 60 allow one roll station to contain roll 44 presently being creped, one roll station containing roll 48 that will be spliced to the end of roll 44, and one roll station for receiving and containing the next roll 52 to be spliced to roll 48. With three roll stations 60, one station will always be free to receive or contain a new roll 52 that will eventually be spliced to roll 48 that will be spliced into roll 44 presently being processed. Of course, any number of roll stations 60 may be provided, depending upon the design of roll feeder 40.

Upstream of creping roll 28, creping system 20 may include one or more applicators 68 of any suitable type, e.g., spray-type, brush-type or roller-type, for applying one or more creping solutions 72 or other conditioning solution(s) to kraft paper 24 prior to the paper engaging and adhering to the creping roll. In this connection, creping roll 28 may be heated to cure creping solution 72 applied to kraft paper 24 to the desired point to properly effect creping. Those skilled in the art will understand that a variety of solutions 72 may be used in creping system 20 such that further explanation is not required for those skilled in the art to understand and practice the present invention.

Depending upon the application of creped paper 76 made with creping system 20, the system may optionally include a calendering station 80 for calendering the creped paper to a desired finished thickness. Calendering station 80 may include any sort of calendering equipment needed for a particular design, such as soft or hard nip rollers 84. Creping system 20 may also optionally include one or more dryers 88 for drying creped paper 76. A winder 96 may also be provided for winding creped paper 76. Of course, if creped paper requires other, or additional, finishes, creping system 20 may be provided with the required finishing equipment (not shown) at the appropriate location(s).

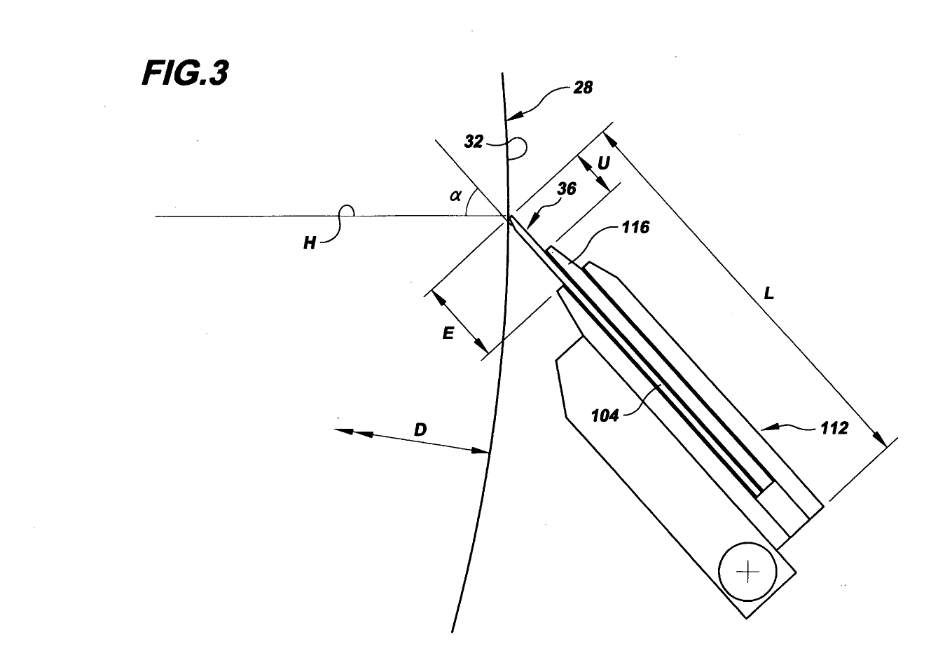

Referring to FIG. 2, and also to FIG. 1, creping blade 36 includes a ceramic tip 100 configured for engaging at least peripheral surface 32 (FIG. 1) of creping roll 28 and a base 104 supporting the ceramic tip. In the embodiment shown, ceramic tip 100 extends beyond the region of contact with peripheral surface 32 so as to form an impact surface 108 that kraft paper 24 impacts upon during the creping process. Base 104 may be made of any suitable material such as steel. Generally, ceramic creping blades similar to creping blade 36 are well known in the tissue paper creping industry, but to the best of the inventor's knowledge, such blades have not been used in the electrical (kraft) paper creping industry. This appears to be so due to the differences between tissue and kraft paper creping. Generally, in the tissue paper creping industry, tissue paper is creped from a yankee dryer, which is a very large diameter (on the order of 9 feet or more) roll/dryer that dries the tissue paper soon after the tissue paper is formed from its pulp. In contrast, a typical kraft paper creping process starts with a roll of pre-made, dry base paper that is subsequently wetted with a creping solution that allows the paper to adhere to the creping roll, which is typically on the order of 2 feet to 4 feet in diameter.

In addition, there is generally a large difference in the composition of the papers used in the tissue paper creping industry and the kraft paper creping industry. This is so due to the differences in the characteristics of the end products. In the tissue paper creping industry, important characteristics of the tissue paper are softness and bulk, whereas in many segments of the kraft paper creping industry, e.g., the electrical insulating paper creping segment, an important feature of the paper is tensile strength. Accordingly, the papers for the two industries are generally made from furnishes having very different compositions. For example, furnishes for tissue paper often contain a relatively large amount of hardwood fibers, which are generally shorter than softwood fibers, that are “cooked” for a relatively long time. The long cooking time and the short fibers tend to yield a soft end product with a relatively low tensile strength. In contrast, furnishes for kraft paper requiring tensile strength as a primary attribute often contain a relatively large amount of softwood fibers that are cooked a relatively short time to maintain their stiffness. Kraft paper particularly suited for use in creping system (FIG. 1) of the present invention, e.g., creping system 20 of FIG. 1, includes kraft paper meeting the ANSI/ASTM D-1305-99 specification discussed in the background section above. Generally, e.g., creping system 20 may be used to crepe kraft paper 24 having a thickness of about 0.5 mils to about 10 mils or more. Very goods results have been achieved for electrical kraft paper meeting the ANSI/ASTM D-1305-99 specification and having a thickness of about 1 mil to about 3 mils.

As discussed in the background section above, creping electrical kraft paper with brass blades requires the blades to be changed after relatively short production runs due to wear that detrimentally affects the quality of the creping. For example, for 2 mil and 3 mil thick kraft paper, it is common to sharpen the brass blade every time a new roll of base paper is about to be creped. As a result, conventional kraft paper creping systems had no need for productivity-increasing equipment, such as auto-splicers that allow multiple base paper rolls to be creped in series with one another without shutting down the system. This is so because the system had to be shut down anyway to replace or sharpen the blade.

In contrast, however, the use of ceramic-tipped creping blade 36 greatly increases the length of the kraft paper 24 that creping system 20 can process before the blade must be replaced due to blade wear detrimentally affecting the quality of creped paper 76. For example, with a 2 mil electrical kraft paper, creping system 20 using ceramic-tipped creping blade 36 has been seen to crepe one million lineal feet and more of kraft paper 24 before blade wear detrimentally affects the creping quality. With typical rolls 44, 48, 52 of 2 mil electrical kraft base paper containing about 13,000 lineal feet each, each ceramic-tipped creping blade 36 can be used to crepe 120 or more rolls of paper, i.e., 1.56 million feet or more. Since creping system 20 of the present invention is not constrained to single-roll processing as are conventional creping systems (not shown) using brass blades, the inventive creping system can benefit from the addition of auto-splicer 64 that automatically splices the beginning of new roll 48 to the end of roll 44 presently being processed without shutting, or even slowing, the system down.

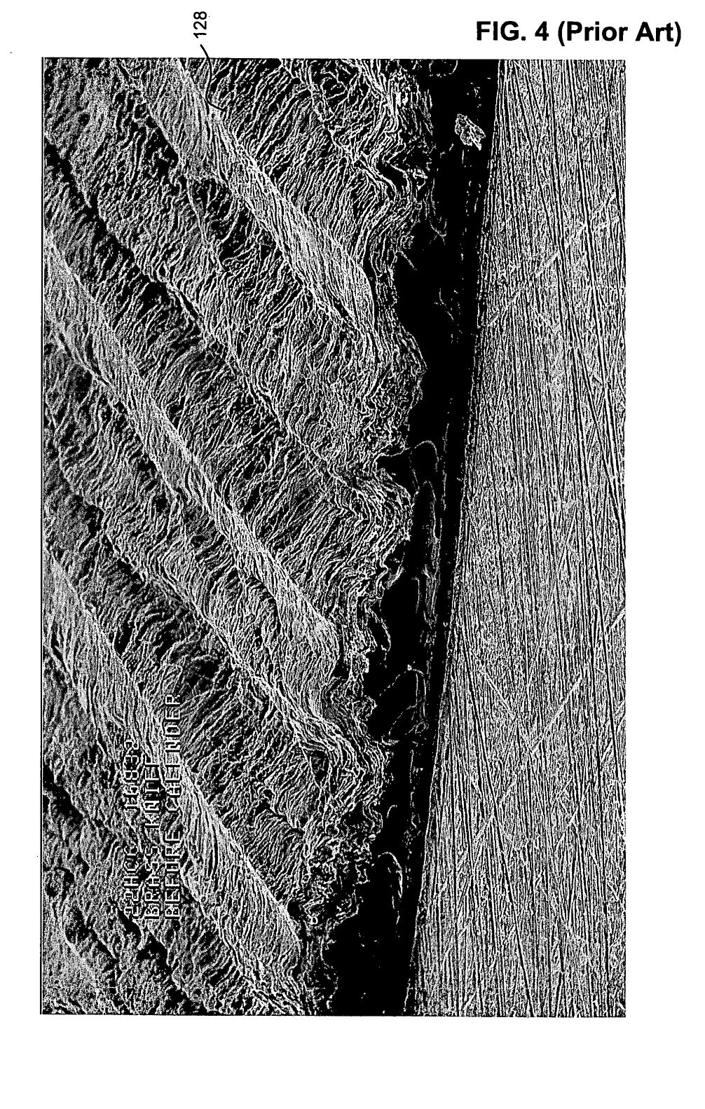

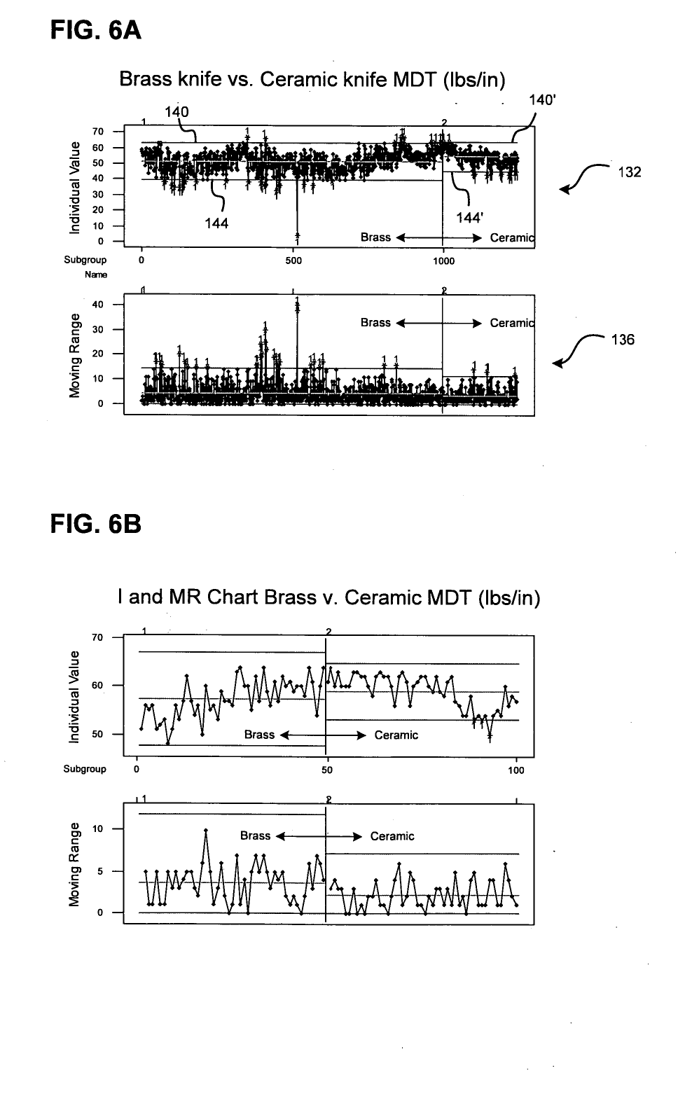

Referring to FIGS. 1 and 3, creping blade 36 may be held in place and in intimate contact with peripheral surface 32 of creping roll 28 by a blade holder 112. Depending upon the length extension of creping blade 36 from holder 112, it may be necessary to utilize a backing bar 116 to limit the bending deflection of the creping blade. In the embodiment of creping system 20 used to make creped paper 76′ shown in the scanning electron micrograph (SEM) of FIG. 5, discussed below, extension E of creping blade 36 from blade holder 112 was about 2.5 inches. The pressure applied by creping blade 36 to creping roll 28 was on the order of 600 psi, which is half of the 1,200 psi that is typically applied by a conventional brass blade. As those skilled in the art will appreciate, the particular setup of creping blade 36 and holder 112 will depend upon a number of variables, including the location of the holder relative to creping roll 28 and location of the contact between the blade and peripheral surface 32 of the roll. In one embodiment wherein creping roll 28 has a diameter of 30 inches, blade holder 112 forms an angle γ of 35.5° relative to a horizontal plane H. Also in this embodiment, creping blade 36 contacts creping roll 28 at mid-height of the roll, i.e., along a line formed by the intersection of horizontal plane H containing the rotational axis of the roll with peripheral surface 32. In addition, the thickness T of base 104 of creping blade 36 was 0.050 inches (1.2 mm), and the extension beyond backing bar 116, i.e., unsupported length U, of about 0.5 inches. The total length L from the tip of creping blade 36 to the distal end of blade holder 112 was about 7.5 inches. This setup of creping blade 36, blade holder 112 and creping roll 28 was used to make creped paper 76′ of FIG. 5.

Referring again to FIG. 2, and also to FIGS. 1 and 3, ceramic tip 100 of creping blade 36 includes in addition to impact surface 108, a sliding surface 120. Sliding surface 120 engages peripheral surface 32 of creping roll 28 and is disposed at a sliding angle a relative to front surface 124 of base 104. Sliding angle a may be any angle suitable for a particular application. In the embodiment used to make creped paper 76′ of FIG. 5 and other similar papers, sliding angle a was initially 20° and the length S of sliding surface 120 was 280 μm. Impact surface 108 of creping blade 36 is impacted by kraft paper 24 adhered to creping roll 28 as the roll rotates and the kraft paper advances through creping system 20. Impact surface 108 may be disposed at an impact angle β, which may be any angle suitable for a particular application. Variables that can affect the choice of impact angle β include the location of the contact between creping blade 36 and creping roll 28 relative to the roll and the desired creping pattern, among others. With the particular setup described herein, impact angle P used were 5°, 10°, 15° and 20°, which provided good results for the various creped papers made. The width I of impact surface 108 was 200 μm for each of the angles β mentioned. Of course, for other creped paper, impact angle β and width I may be different as needed.

As mentioned above, ceramic creping blades are well known in the tissue paper creping industry and are available for the tissue creping industry from manufacturers such as BTG Americas, Inc., Norcross, Ga. However, the configuration of ceramic tip 100 may have to be customized for a particular blade setup for kraft paper creping, since, as mentioned above, tissue paper creping systems are typically much different than kraft paper creping systems, such as system 20 of the present invention. The configuration of creping blade 36 discussed in the immediately preceding paragraph was a custom configuration that was specially requested and made.

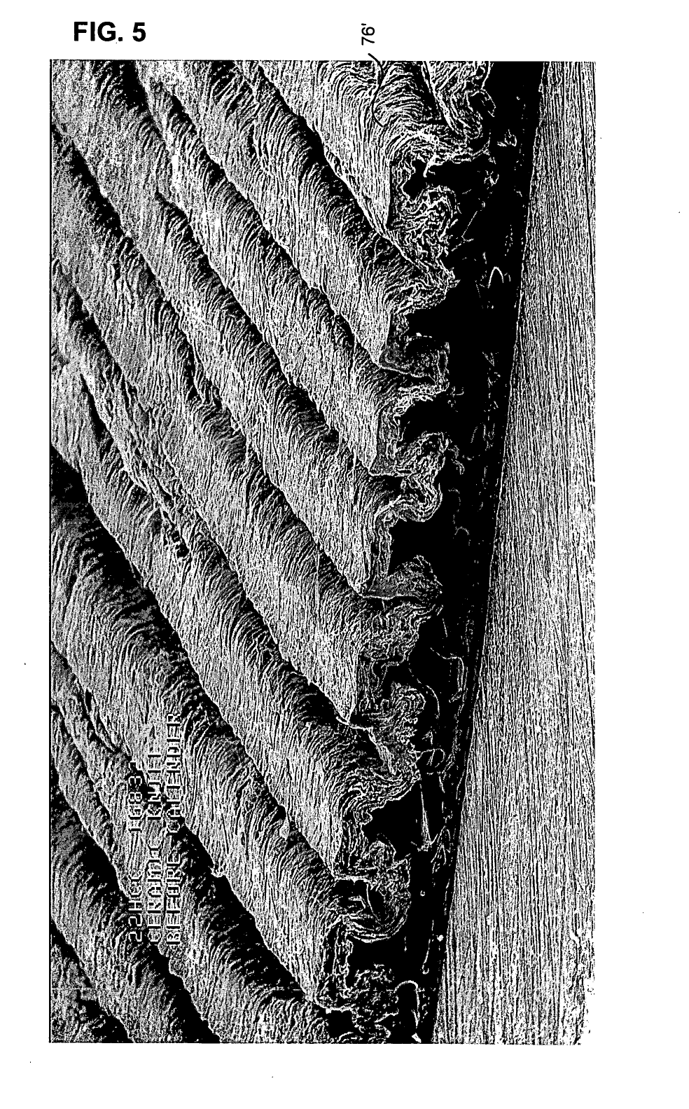

FIG. 4 shows an SEM of a prior art creped paper 128 made using the setup shown in FIG. 3, except that creping blade 36 was replaced with a conventional brass creping blade, (not shown). As can be seen in FIG. 3, the amplitude of the creping pattern is about 250 μm, but is characterized by a somewhat irregular pattern of not-so-well defined peaks and valleys defined by shallow slopes of about 25° or less relative to the plane of creped paper. In addition, not seen in this SEM but present in creped paper 128 is the relatively large discontinuity of the creping pattern in the cross-machine direction, i.e., generally in the direction along the length of the peaks and valleys.

In contrast, FIG. 5 shows creped paper 76′ made with the setup shown in FIG. 3 using the same base kraft paper used for crepe paper 128 of FIG. 4, but wherein the creping blade was ceramic-tipped blade 36 discussed above. In this case, impact angle β (FIG. 2) of creping blade 36 was 15°. It is noted that all parameters other than the type of creping blade and the creping blade setup for making creped paper 76′ were the same as the parameters used to make creped paper 128 of FIG. 4. That is, the parameters such as type and amount of creping solution 72 applied to the base kraft paper, temperature of creping roller 28 and composition of the base kraft paper were unchanged. It can readily be seen that the creping pattern of creped paper 76′ of FIG. 5 made using ceramic-tipped creping blade 36 is much different than the creping pattern of creped paper 128 of FIG. 4. For example, although the amplitude of the creping pattern of creped paper 76′ is approximately the same 250 μm as the amplitude of the creping pattern of FIG. 4, the “peaks” of creped paper 76′ of FIG. 5 are generally defined by plateaus and the valleys are defined by walls that are much steeper than the gentle slopes of FIG. 4. In fact, the slopes of the walls of each valley of creped paper 76′ relative to the plane of the paper is generally 80° to 90°. Other samples made using creping system 20 had valley walls with slopes generally consistently greater than 45°. In addition, the creping pattern along the machine direction is much more uniform in creped paper 76′ than in crepe paper 128 made using a brass blade. Moreover, although not seen in FIG. 5, the creping pattern of creped paper 76′ is substantially continuous in the cross-machine direction.

Whereas FIGS. 4 and 5 show the creping patterns of respective creped papers 128, 76′, for many applications the creped paper is often calendered in forming a final product. For example, in the electrical insulation paper industry, creped papers are typically calendered to form the final electrical insulation papers. As discussed in the background section above, creped and calendered kraft paper is often used to insulate magnet wires of transformer windings. In addition to needing to provide certain electrical insulating requirements, magnet wire insulating paper must meet or exceed certain tensile strength and elongation requirements. Generally, tensile strength and elongation characteristics together correlate to the ability of the electrical insulation paper to resist breakage during both winding of the paper onto magnet wires and during creping and calendering.

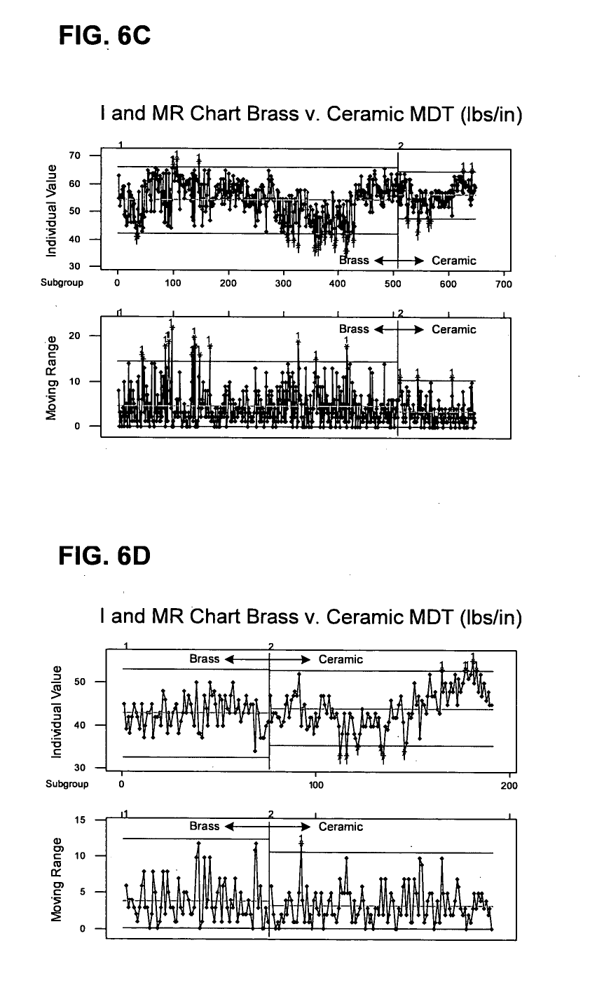

The individual (I) and moving range (MR) charts 132, 136 of FIG. 6A illustrate the enhanced machine direction tensile (MDT) strength characteristics of creped paper 76′ (FIG. 5) (after calendering) made with ceramic-tipped creping blade 36 (FIGS. 1-3) relative to creped paper 128 (FIG. 4) (after calendering) made with a brass creping blade, other parameters being equal. I- and MR-charts 132, 136 were produced from over 1,250 samples using the six-sigma methodology. From I-chart 132, it is seen that the tensile strength increased from about 51.5 pounds per inch (ppi) with the brass blade to about 54.7 ppi per inch with ceramic-tipped blade, an increase of about 6.2%. Other creped and calendered papers made in accordance with the present invention have been tested and have displayed increases in MDT strength of between about 4% and 7% over creped paper made from the same based paper using the same equipment and parameters, but with brass blades. Generally, this indicates that ceramic-tipped blade 36 is less destructive to kraft paper 24 that a brass blade.

I-chart 132 also shows that the upper control limit (UCL) 140 and lower control limit (LCL) 144 for the brass blade are, respectively, about 63.5 ppi and about 40 ppi. Similarly, UCL 140′ and LCL 144′ for ceramic tipped blade 36 (FIGS. 1-3) are respectively, about 64 ppi and about 45.5 ppi. Accordingly, in addition to the increase in mean tensile strength overall, I-chart 132 shows that the variation of the tensile strength of the paper made using ceramic-tipped blade 36 over multiple samples (about 18 ppi) is less than such variation across many samples made using a brass blade (about 23.5 ppi). Similar and greater decreases in variation, e.g., up to 40% or more, have been observed in other comparisons (see, e.g., FIGS. 6B-6D).

In addition to the increases in mean tensile strength and decreases in tensile strength variations relative to creped papers made using brass blades as just discussed, it has been observed that creped kraft papers 76, 76′ made in accordance with the present invention have at times experienced increases in machine direction elongatability (MDE) of about 2% to about 4% or greater relative to creped papers made from the same base kraft paper with the same process parameters, but with a brass blade. It has further been observed that the efficiency and yield of creping roll/blade setup may increase using ceramic-tipped creping blade.

The reduced detriment to tensile strength and greater elongatability relative can have a number of benefits. For example, as mentioned above, increases in tensile strength and elongatability relative to creped paper made using brass blades can result in less breakage since the creped paper is stronger and more forgiving. As a consequence, it is possible to run creping system 20 at speeds higher than could be achieved with a brass creping blade that produces a creped paper having lower strength and elongatability. Similarly, speed gains may also be realized during use of the creped insulation paper, e.g., during winding of magnet wires (not shown).

An additional benefit that may result from the fact that creped paper, e.g., creped paper 76′ of FIG. 5, made with ceramic-tipped creping blade has increased tensile strength and elongatability is that for a particular product having to meet certain tensile strength and elongatability requirements a lower grade of base paper may be used. In other words, due to the enhanced properties of the creped paper made with creping system 20 of the present invention, it may be possible to meet specifications with a lower grade of base paper, which can translate into lower cost. For example, for a product that requires base paper made using a drum process to meet specifications when made with a brass creping blade may need only a lower grade paper in order to meet the same specifications.

A further benefit of the present invention is that ceramic-tipped creping blade 36 is less destructive to kraft paper 24 than a brass blade and creped paper 76 can be brought into specifications more quickly as compared to a brass blade. Consequently, the use of ceramic-tipped blade 36 results in less out-of-specifications, startup waste of kraft paper 24 and less time bringing creped paper 76 into specifications.

Yet another benefit particularly important for the electrical insulating paper industry is the elimination of the paper being contaminated with metal dust resulting from a metal blade contacting a metal crepe roll. Ceramic-tipped blade 36 of the present invention virtually eliminates this sort of contamination. In conventional creped insulating papers, the metal dust tends to degrade the dielectric properties of the paper that are critical for electrical insulation.

While the present invention has been described in connection with a preferred embodiment, it will be understood that it is not so limited. On the contrary, it is intended to cover all alternatives, modifications and equivalents as may be included within the spirit and scope of the invention as defined above and in the claims appended hereto.

1. A method of converting paper, comprising the steps of:
(a) providing a first web of kraft paper;
(b) adhering said first web to a roller; and
(c) creping said first web from said roller with a creping blade having a ceramic tip.

2. A method according to claim 1, further comprising the step of splicing a second web to said first web.

3. A method according to claim 1, wherein step (a) includes supplying said first web of kraft paper as a roll of pre-dried kraft paper.

4. A method according to claim 1, wherein said kraft paper comprises at least 60 percent virgin softwood fiber.

5. A method according to claim 1, wherein said kraft paper comprises 100 percent unbleached sulfate fibers.

6. A method according to claim 1, wherein said kraft paper is electrical kraft paper.

7. A method according to claim 6, wherein said kraft paper has a thickness of at least 1.5 mils.

8. A method according to claim 7, wherein said kraft paper has a thickness of at least 3 mils.

9. A method according to claim 1, wherein said kraft paper has a thickness of at least 1.5 mils.

10. A method according to claim 9, wherein said kraft paper has a thickness of at least three mils.

11. A method according to claim 1, wherein said first web defines a plane and step (c) includes imparting into said first web a creping pattern having a plurality of peaks and valleys, each of said valleys being defined by a pair of walls each having a slope of at least 45° relative to said plane.

12. A method according to claim 11, wherein said web has a thickness of at least 1.5 mils.

13. A system for converting paper, comprising:
(a) a first web of kraft paper;
(b) a roll having a peripheral surface for adheringly receiving said first web; and
(c) a creping blade having a ceramic tip engaging said peripheral surface, said creping blade removing said first web from said peripheral surface so as to impart a creping pattern into said first web.

14. A system according to claim 13, further comprising an auto-splicer for splicing a second web to said first web.

15. A system according to claim 13, wherein said kraft paper comprises at least 60 percent virgin softwood fiber.

16. A system according to claim 13, wherein said kraft paper comprises 100 percent unbleached sulfate fibers.

17. A system according to claim 13, wherein said kraft paper is electrical kraft paper.

18. A system according to claim 17, wherein said kraft paper has a thickness of at least 1.5 mils.

19. A system according to claim 18, wherein said kraft paper has a thickness of at least 3 mils.

20. A system according to claim 13, wherein said kraft paper has a thickness of at least 1.5 mils.

21. A system according to claim 20, wherein said kraft paper has a thickness of at least three mils.

22. A system according to claim 13, wherein said creping pattern has a plurality of peaks and valleys, each of said valleys being defined by a pair of walls each having a slope of at least 45° relative to said plane.

23. A system according to claim 13, wherein said roll has a rotational axis disposed in a horizontal plane, said ceramic tip engaging said peripheral surface substantially along a line where said horizontal plane intersects said peripheral surface, said blade forming an angle between 30° and 40° relative to said horizontal plane.

24. A system according to claim 23, wherein said angle is about 35.5°.

25. A system according to claim 23, wherein said roll has a diameter between 25 inches and 35 inches.

26. A system according to claim 23, wherein said blade has an unsupported length substantially tangent to said roll of about 2.5 inches.

27. A system according to claim 13, further comprising an unwinding station for supplying to said roll said first web of kraft paper.

28. A system according to claim 13, wherein said roll has a diameter less than about 36 inches.

29. A system for converting paper, comprising:
(a) a first roll of electrical kraft paper;
(b) a second roll of electrical kraft paper;
(c) a roll having a peripheral surface for adheringly receiving said electrical kraft paper;
(d) a creping blade adapted for removing said first electrical kraft paper from said peripheral surface so as to impart a creping pattern into said electrical kraft paper; and
(e) an auto-splicer located between said first and second rolls for splicing said second roll to said first roll.

30. A system according to claim 29, wherein said creping blade includes a ceramic tip for engaging said peripheral surface.

31. Electrical insulation, comprising:
(a) an electrical kraft paper having a machine direction and defining a plane;
(b) a creping pattern imparted into said electrical kraft paper along the machine direction and having a plurality of peaks and a plurality of valleys, each of said plurality valleys defined by a pair of walls each having a slope of at least 45° relative to said plane.

32. Electrical insulation according to claim 31, wherein each one of said plurality of peaks defines a plateau.

33. Electrical insulation according to claim 31, wherein said electrical kraft paper has a thickness of at least about 2 mils.

34. Electrical insulation according to claim 33, wherein said slope of each one of said pair of walls is at least 700.

35. Electrical insulation according to claim 31, wherein said electrical kraft paper has a thickness of at least about 3 mils.

36. Electrical insulation, comprising:
(a) a creped and calendered electrical kraft paper having:
(i) a thickness of about 3 mils;
(ii) a machine direction tensile strength of greater than 58.5 pounds per inch.

37. Electrical insulation according to claim 36, wherein said kraft paper has an elongatability of at least 20 percent.

38. Electrical insulation according to claim 36, wherein said kraft paper comprises 100 percent unbleached sulfate fibers.

39. Electrical insulation, comprising:
(a) a first blade-creped and calendered electrical kraft paper, made from a base kraft paper using a set of process parameters, having a machine direction tensile strength at least 4 percent greater than the machine direction tensile strength of a second blade-creped and calendered electrical kraft paper made from said base kraft paper using a metal-tipped creping blade and said process parameters.

40. Electrical insulation according to claim 39, wherein said first blade-creped and calendered electrical kraft paper has a machine direction tensile strength at least 6 percent greater than the machine direction tensile strength of said second blade-creped and calendered electrical kraft paper.

41. Electrical insulation according to claim 39, wherein said first blade-creped and calendered electrical kraft paper has a machine direction elongatability at least 2 percent greater than the machine direction elongatability of said second blade-creped and calendered electrical kraft paper.

42. Electrical insulation according to claim 41, wherein said first blade-creped and calendered electrical kraft paper has a machine direction elongatability at least 4 percent greater than the machine direction elongatability of said second blade-creped and calendered electrical kraft paper.
